(19) United States
(12) Patent Application Publication
(10) Pub. No.: US 2009/0266086 A1
(43) Pub. Date: Oct. 29, 2009

(54) FLOATING MARINE STRUCTURE HAVING LNG CIRCULATING DEVICE

(75) Inventors: JUNG HAN LEE, Geoje-Si (KR); DONG KYU CHOI, Geoje-Si (KR); YOUNG SIK MOON, Geoje-Si (KR); YOUNG SOO KIM, Geoje-Si (KR)

Correspondence Address: KNOBBE MARTENS OLSON & BEAR LLP, 2040 MAIN STREET, FOURTEENTH FLOOR, IRVINE, CA, 92614, US

(73) Assignee: DAEWOO SHIPBUILDING & MARINE ENGINEERING CO., LTD., SEOUL (KR)

(21) Appl. No.: 12/429,145

(22) Filed: Apr. 23, 2009

(30) Foreign Application Priority Data
Apr. 29, 2008 (KR) 10-2008-0040038

(51) Int. Cl. F17C 3/00; F17C 9/02; F17C 13/00

(52) U.S. Cl. 62/48.1; 62/48.2; 62/53.2

(57) ABSTRACT

Disclosed is an apparatus for containing LNG. The apparatus includes an LNG tank containing liquid phase LNG and boil-off gas of LNG, and an circulating device. The circulating device includes an intake port and a discharge port. The circulating device further includes an flowing pathway from the intake port to the discharge port that does not include a forced LNG liquefying device. The intake port is located in an upper portion of the LNG tank, and the discharge port is located in a lower portion of the LNG tank substantially lower than the intake port. The circulating device is configured to suction, through the intake port, boil-off gas from the upper portion of the LNG tank and to discharge boil-off gas, through the discharge port, to the lower portion of the LNG tank.

### CROSS-REFERENCE TO RELATED APPLICATION

This application claims priority to and the benefit of Korean Patent Application No. 10-2008-0040038, filed Apr. 29, 2008, the disclosure of which is incorporated herein by reference in its entirety.

### BACKGROUND

1. Field

The present disclosure relates to a floating marine structure having a liquefied natural gas (LNG) tank, and more particularly, to a floating marine structure having a LNG circulating device.

2. Discussion of the Related Technology

In recent, the amount of consumption of natural gas has been increased rapidly throughout the world. Natural gas which is in a gas state is transported through a gas pipe line installed on the land or in the sea, or natural gas which is in an LNG state is transported by an LNG carrier (in particular, an LNG transport vessel) to distant markets while the liquefied natural gas is stored in the LNG carrier. Liquefied natural gas is produced by cooling natural gas at an extremely low temperature (approximately −163° C.), and a volume of the liquefied natural gas is approximately 1/600 of a volume of natural gas which is in a gas state, so that marine transportation is suitable for a long-distance transportation of liquefied natural gas.

The LNG transport vessel is to load LNG, sail on the sea and unload the LNG to a land market. To this end, the LNG transport vessel comprises an LNG storage tank (in general, referred to as “cargo containment”) which can withstand an extremely low temperature of liquefied natural gas. In general, liquefied natural gas stored in the LNG storage tank of the LNG transport vessel is unloaded to a land in a liquid state. The LNG unloaded on a land is re-gasified in LNG re-gasification facilities installed on the land, and then, the re-gasified natural gas is transported to markets via gas lines.

The foregoing discussion in the background section is to provide general background information, and does not constitute an admission of prior art.

### SUMMARY

One aspect of the invention provides a floating marine structure, comprising: a liquefied natural gas (LNG) storage tank configured to accommodate LNG; an LNG re-gasification apparatus configured to re-gasify LNG accommodated in the LNG storage tank; and an in-tank re-condensing unit configured to re-condense boil-off gas generated in the LNG storage tank by spraying the boil-off gas toward a lower portion of the LNG storage tank, wherein the boil-off gas is returned to the LNG storage tank through the in-tank re-condensing unit, whereby the boil-off gas is re-condensed in the LNG storage tank.

In the foregoing structure, the in-tank re-condensing unit may comprise a nozzle installed to the lower portion of the LNG storage tank. The floating marine structure may further comprise a boiler to supply heat for re-gasification of LNG, wherein when the LNG re-gasification apparatus are not operated, the boil-off gas is returned to the LNG storage tank through the in-tank re-condensing unit, and when the LNG re-gasification facilities are operated, the boil-off gas is burned in the boiler to generate heat which is supplied to the LNG re-gasification apparatus.

Still in the foregoing structure, the structure may further comprise a re-condenser for re-liquefying the boil-off gas generated in the LNG storage tank. The floating marine structure may further comprise a boil-off gas supply line configured to flow at least a portion of the boil-off gas generated in the LNG storage tank to the boiler through a compressor. The structure may further comprise a boil-off gas supply line configured to flow at least a portion of the boil-off gas generated in the LNG storage tank to the re-condenser via a compressor. The floating marine structure may further comprise a boiler to supply heat for re-gasification of LNG, and a boil-off gas discharge line branching off from the boil-off gas supply line and configured to supply another portion of the boil-off gas to the boiler. The structure may further comprise a boil-off gas return line configured to supply at least a portion of the boil-off gas generated in the LNG storage gas to the in-tank re-condensing unit through the compressor.

Another aspect of the invention provides an apparatus for containing LNG, the apparatus comprising: an LNG tank containing liquid phase LNG and boil-off gas of LNG; an circulating device comprising an intake port and a discharge port, the circulating device further comprising an flowing pathway from the intake port to the discharge port that does not include a forced LNG liquefying device; the intake port being located in an upper portion of the LNG tank; and the discharge port being located in a lower portion of the LNG tank substantially lower than the intake port, wherein the circulating device is configured to suction, through the intake port, boil-off gas from the upper portion of the LNG tank and to discharge boil-off gas, through the discharge port, to the lower portion of the LNG tank.

In the foregoing apparatus, the circulating device may further comprise a compressor configured to compress at least part of the boil-off gas flowing in the flowing pathway between the intake port and the discharge port. The intake port may be located at or near a top surface of the LNG tank. The discharge port may be substantially distanced from an interior surface of the LNG tank. The circulating device may further comprise a branch pathway branching from the flowing pathway and not returning to the flowing pathway. The flowing pathway may comprise a portion located outside the LNG tank.

Still another aspect of the invention provides a ship comprising the foregoing apparatus, wherein the LNG tank is integrated with a body of the ship. In the foregoing ship, the LNG tank may comprise an outlet configured to discharge liquid phase LNG therethrough when unloading the LNG from the LNG tank, wherein the ship may further comprise an evaporator configured to evaporate liquid phase LNG discharged through the outlet. The ship may further comprise a burner, wherein the burner may be connected to the circulating device so as to receive at least part of boil-off gas flowing between the intake port and the discharge port. The ship may further comprise a mixer connected to the evaporator and further connected to the LNG circulating device, whereby the mixer is configured to mix the LNG discharged from the outlet and a portion of LNG flowing between the intake port and the discharge port.

A further aspect of the invention provides a method of processing boil-off gas of LNG contained in a LNG tank, the method comprising: providing the foregoing apparatus; suctioning, through the intake port, boil-off gas from the upper portion of the LNG tank; flowing, through the flowing pathway, boil-off gas from the intake port toward the discharge port; and discharging, through the discharge port, boil-off gas from the flowing pathway into the lower portion of the LNG tank.

In the foregoing method, the method may further comprise: compressing at least part of boil-off gas flowing in the flowing pathway toward the discharge port; and flowing compressed boil-off gas toward the discharge port. Substantially no liquid phase LNG may be suctioned through the intake port. The discharge port may be submerged in liquid phase LNG.

One aspect of the invention provides an apparatus for containing LNG, the apparatus comprising: an LNG tank containing LNG; an LNG circulating device comprising an intake port and a discharge port, the LNG circulating device further comprising an LNG flowing pathway from the intake port to the discharge port that does not include a forced LNG liquefying device; the intake port being located in an upper portion of the LNG tank; and the discharge port being located in a lower portion of the LNG tank substantially lower than the intake port, wherein the LNG circulating device is configured to suction, through the intake port, LNG from the upper portion of the LNG tank and to discharge LNG, through the discharge port, to the lower portion of the LNG tank.

In the foregoing apparatus, the LNG contained in the LNG tank may comprise a liquid phase and a gaseous phase, wherein the circulating device may be configured to suctioning gaseous phase LNG. The LNG circulating device may further comprise a compressor configured to compress at least part of the LNG flowing in the LNG flowing pathway between the intake port and the discharge port. The intake port may be located at or near a top surface of the LNG tank. The intake port may be substantially distanced from an interior surface of the LNG tank.

Still in the foregoing apparatus, the LNG circulating device may further comprise a branch pathway branching from the LNG flowing pathway and returning to the LNG flowing pathway. The branch pathway may comprise a forced liquefying device configured to liquefy LNG flowing through the branch pathway. The LNG circulating device may further comprise a branch pathway branching from the LNG flowing pathway and not returning to the LNG flowing pathway. The discharge port may comprise a plurality of orifices. The LNG flowing pathway may comprise a portion located outside the LNG tank.

Another aspect of the invention provides a ship comprising the foregoing apparatus, wherein the LNG tank may be integrated with a body of the ship. In the foregoing ship, the LNG tank may comprise an outlet configured to discharge liquid phase LNG therethrough when unloading the LNG from the LNG tank, wherein the outlet may be lower than the discharge port of the LNG circulating device, wherein the ship may comprise an evaporator configured to evaporate liquid phase LNG discharged through the outlet. The ship may further comprise a burner, wherein the burner may be connected to the LNG circulating device so as to receive at least part of LNG flowing between the intake port and the discharge port. The ship may further comprise a mixer connected to the evaporator and further connected to the LNG circulating device, whereby the mixer is configured to mix the liquid phase LNG discharged from the outlet and a portion of LNG flowing between the intake port and the discharge port.

A further aspect of the invention provides a method of processing LNG contained in a LNG tank, the method comprising: providing the foregoing apparatus; suctioning, through the intake port, LNG from the upper portion of the LNG tank; flowing, through the LNG flowing pathway, LNG from the intake port toward the discharge port; and discharging, through the discharge port, LNG from the LNG flowing pathway into the lower portion of the LNG tank.

The foregoing method may further comprise: compressing at least part of LNG flowing in the LNG flowing pathway toward the discharge port; and flowing compressed LNG toward the discharge port. In the foregoing method, at least part of the LNG flowing from the intake port toward the discharge port may be condensed while flowing through the LNG flowing pathway with no forced liquefying process. Substantially all LNG discharged through the discharge port may be liquid phase LNG. At least part of the LNG discharged through the discharge port may be gaseous phase LNG. Substantially no liquid phase LNG may be suctioned through the intake port. The discharge port may be submerged in liquid phase LNG.

The foregoing method may further comprise: unloading liquid phase LNG from the LNG tank; gasifying the liquid phase LNG to gaseous phase LNG; supplying the gaseous phase LNG to an LNG infrastructure for supplying LNG to consumers. In the foregoing method, when unloading liquid phase LNG from the LNG tank, discharging through the discharge port may be stayed. Discharging through the discharge port and unloading liquid phase LNG from the LNG tank may be alternating.

An aspect of the invention provides a floating marine structure having an in-tank re-condensing unit, wherein boil-off gas generated in a liquefied gas storage tank is compressed at low pressure and boil-off gas is returned to the storage tank, thereby saving power consumed due to a re-condenser in which boil-off gas is compressed at high pressure, and a method of treating boil-off gas in the floating marine structure.

According to an aspect of the present invention, there is provided a floating marine structure, which comprises a liquefied natural gas (LNG) storage tank for accommodating extremely low temperature LNG; LNG re-gasification facilities for re-gasifying LNG accommodated in the LNG storage tank; and an in-tank re-condensing unit for re-condensing boil-off gas generated in the LNG storage tank by spraying the boil-off gas toward a lower portion of the LNG storage tank, wherein the boil-off gas is returned to the LNG storage tank through the in-tank re-condensing unit, whereby the boil-off gas is re-condensed in the LNG storage gas.

Preferably, the in-tank re-condensing unit is a nozzle installed to the lower portion of the LNG storage tank. The floating marine structure may further comprise a boiler included in the LNG re-gasification facilities to supply heat for re-gasification, wherein when the LNG re-gasification facilities are not operated, the boil-off gas may be returned to the LNG storage tank through the in-tank re-condensing unit to allow a pressure in the LNG storage tank to be increased, and when the LNG re-gasification facilities are operated, the boil-off gas may be burned in the boiler to generate steam and the steam may be supplied to the LNG re-gasification facilities as a heat source.

Preferably, the floating marine structure further comprises a condenser for condensing steam, which is generated in the boiler but is not supplied to the LNG re-gasification facilities. Preferably, the floating marine structure further comprises a re-condenser for re-liquefying the boil-off gas generated in the LNG storage tank. The floating marine structure may further comprise a boil-off gas supply line for supplying all the boil-off gas generated in the LNG storage tank to the boiler through a compressor, whereby a gas combustion unit or a flare for treating surplus boil-off gas can be eliminated.

Preferably, the floating marine structure further comprises a boil-off gas supply line for supplying a portion of the boil-off gas generated in the LNG storage tank to the re-condenser via a compressor. Preferably, the floating marine structure further comprises a boiler included in the LNG re-gasification facilities to supply heat for re-gasification; and a boil-off gas discharge line branching off from the boil-off gas supply line to supply the boiler with the remainder of the boil-off gas, which is generated in the LNG storage gas but is not supplied to the re-condenser, whereby a gas combustion unit or a flare for treating surplus boil-off gas can be eliminated.

Preferably, the floating marine structure further comprises a boil-off gas return line for supplying all the boil-off gas generated in the LNG storage gas to the in-tank re-condensing unit through the compressor, whereby a gas combustion unit or a flare for treating surplus boil-off gas and a re-condenser can be eliminated. Preferably, the floating marine structure further comprises an evaporator for re-gasifying the LNG supplied from the LNG storage tank, wherein the boil-off gas is mixed with the LNG supplied from the LNG storage tank, re-condensed, and then, supplied to the evaporator together with LNG. Preferably, the floating marine structure includes any one selected from LNG re-gasification vessel (RV) and LNG floating storage and re-gasification unit (FSRU) equipped with the LNG re-gasification facilities.

According to another aspect of the present invention, there is provided a floating marine structure, which comprises an LNG storage tank for accommodating extremely low temperature LNG; LNG re-gasification facilities for re-gasifying LNG accommodated in the LNG storage tank; a boiler included in the LNG re-gasification facilities to supply heat for re-gasification; and an in-tank re-condensing unit for re-condensing boil-off gas generated in the LNG storage tank by spraying the boil-off gas toward a lower portion of the LNG storage tank, wherein the boil-off gas is returned to the LNG storage tank through the in-tank re-condensing unit to allow pressure in the LNG storage tank to be increased, and when the LNG re-gasification facilities are operated, the boil-off gas is burned in the boiler to generate steam and the steam is supplied to the LNG re-gasification facilities as a heat source.

According to a further aspect of the present invention, there is provided a floating marine structure having liquefied gas re-gasification facilities, which comprises a liquefied gas storage tank having a reinforced structure for allowing internal pressure thereof to be increased; and an in-tank re-condensing unit for spraying boil-off gas generated in the liquefied gas storage tank to the liquefied gas storage tank.

Preferably, the floating marine structure further comprises a boiler for burning the boil-off gas to generate steam and supplying the steam as a heat source for re-gasification when the liquefied gas re-gasification facilities are operated. Preferably, the floating marine structure further comprises a condenser for condensing the steam which is not supplied to the liquefied gas re-gasification facilities. Preferably, the floating marine structure further comprises a low pressure compressor for compressing the boil-off gas, which is returned to the liquefied gas storage tank through the in-tank re-condensing unit, at low pressure.

According to a still further aspect of the present invention, there is provided a method of treating boil-off gas in a floating marine structure having a liquefied gas storage tank and liquefied gas re-gasification facilities, which comprising the steps of discharging boil-off gas generated in the liquefied gas storage tank to the outside; compressing the discharged boil-off gas at low pressure; and returning the boil of gas compressed at low pressure to the liquefied gas storage tank, whereby the discharged boil-off gas is compressed at high pressure and then is not re-condensed, so that an energy consumed for compressing the boil-off gas at high pressure can be reduced.

Preferably, the method of treating boil-off gas further comprises the step of using the boil-off gas generated in the liquefied gas storage tank as fuel of a boiler for supplying heat for re-gasification while the re-gasification is performed by the liquefied gas re-gasification facilities.

### BRIEF DESCRIPTION OF THE DRAWINGS

FIG. 1 is a view illustrating an example of method of treating boil-off gas;

FIG. 2 is a view schematically showing the configuration of a floating marine structure having LNG re-gasification facilities according to an embodiment of the present invention; and

FIG. 3 is a view schematically showing the configuration of a floating marine structure having LNG re-gasification facilities according to an embodiment of the present invention.

### DESCRIPTION OF EMBODIMENTS

Various embodiments will be described in detail below. Generally, it is economically advantageous to provide the LNG re-gasification facilities on the land at regions where markets for natural gas are formed and natural gas is stable demand. However, in the natural gas markets where a demand for natural gas is varied seasonally, periodically or in a short term, it is economically extremely disadvantageous to provide the LNG re-gasification facilities on the land due to high installation and management expenses.

In particular, the transportation of natural gas using a LNG transport vessel has a limitation in that if the LNG re-gasification facilities provided on the land are damaged by natural disasters, LNG cannot be re-gasified in the LNG re-gasification facilities although the LNG transport vessel in which LNG is loaded arrives at the market.

Accordingly, a marine LNG re-gasification system, in which LNG re-gasification facilities are provided on an LNG transport vessel or a marine floating structure to re-gasify natural gas on the sea and the natural gas generated by re-gasification can be supplied to a land, has been developed.

A ship such as an LNG re-gasification vessel (RV) or a structure such as LNG floating storage and re-gasification unit (FSRU) can be utilized as examples of the marine structures equipped with re-gasification facilities for re-gasifying LNG. In addition to the above, the re-gasification facilities for re-gasifying LNG may be provided in the marine structure such as an LNG floating, production, storage and off-loading (FPSO).

The LNG RV is constructed by installing LNG re-gasification facilities to an LNG transport vessel which can sail and float itself, and the LNG FSRU is a floating marine structure, which stores liquefied natural gas unloaded from the LNG transport vessel anchored on the sea far away from on a land in a storage tank, gasifies liquefied natural gas, if necessary, and supplies gasified natural gas to land markets. In addition, the LNG FPSO is a floating marine structure utilized for liquefying produced natural gas directly on the sea, storing it in an LNG storage tank and transferring the LNG stored in the LNG storage tank to the LNG transport vessel, if necessary.

A temperature of liquefaction of natural gas is an extremely low temperature of approximately −163° C. at the ambient pressure, so that LNG is evaporated at a temperature slightly higher than about −163° C. at the ambient pressure. An example of the LNG transport vessel will be described below. In this LNG transport vessel, although an LNG storage tank is insulated, since external heat is continuously transferred to the LNG storage tank, LNG is continuously gasified in the LNG storage tank to generate boil-off gas in the LNG storage tank while LNG is transported by the LNG transport vessel.

If boil-off gas is continuously generated in the LNG storage tank as described above, the pressure in the LNG storage tank is increased, which is dangerous. Typically, in order to keep the pressure in the LNG storage tank stable, boil-off gas generated in the LNG storage tank is often utilized as propelling fuel of the LNG transport vessel. That is, in case of an LNG transport vessel for transporting LNG in a liquid state at a low temperature, LNG in the storage tank is maintained at a temperature of about −163° C. at the nearly ambient pressure during the transportation of LNG. Accordingly, boil-off gas generated in the storage tank is discharged out of the storage tank and then treated.

However, if boil-off gas generated in the LNG storage tank is used as fuel of a steam turbine engine for propelling the vessel, the propelling efficiency would be low. In addition, a dual fuel diesel electric propulsion system, in which boil-off gas generated in the LNG storage tank is compressed and used as fuel of a diesel engine, has a higher efficiency as compared with a steam turbine propulsion system, but has a trouble in maintaining the equipment due to a sophisticated mid-speed engine and electrical propulsion device.

In addition, since boil-off gas is supplied as fuel in such a method, a method for compressing gas, which requires high installation and operation costs as compared with a case of compressing liquid, is applied. Further, the energy efficiency of the method in which boil-off gas is utilized as propelling fuel cannot come up to the energy efficiency of a two-stroke low speed diesel engine employed for a general vessel under all circumstances.

On the other hand, there is a method in which boil-off gas generated in the LNG storage tank is re-liquefied and then returned to the LNG storage tank. However, in the method of re-liquefying boil-off gas, a boil-off gas re-liquefying device having a complicated system would need to be provided on the LNG transport vessel.

Also, in a case where boil-off gas can be used as fuel in a propulsion device or the excessive amount of boil-off gas larger than the treating capacity of the boil-off gas re-liquefying device is generated, surplus boil-off gas is treated by being burned or discharged in a gas combustion unit or a flare, additional facilities such as a gas combustion unit or a flare for treating surplus boil-off gas would need to be provided.

As one example, the LNG transport vessel having a basic concept in which a typical LNG storage tank is maintained in a substantially constant pressure state will be described. In the early state (within 3 to 5 days) after LNG is loaded, the LNG storage tank is not sufficiently cooled by LNG of extremely low temperature, so that a remarkably large quantity of excess boil-off gas is generated as compared with the amount of natural boil-off gas generated during sailing of the LNG transport vessel, wherein the amount of this excessive boil-off gas is larger than the amount of fuel consumed in the vessel propulsion system.

Accordingly, excessive boil-off gas except the amount of boil-off gas consumed in the vessel propulsion system is burned in the gas combustion unit or discharged through the flare. In addition, in a case where the LNG transport vessel passes through a canal, no boil-off gas is consumed in the boiler or engine (when the LNG transport vessel is anchored in the canal) or small amount of boil-off gas is consumed (when the LNG transport vessel passes through the canal), so that excessive boil-off gas except the amount of boil-off gas required in the engine is discharged. Also, even in a case where the LNG transport vessel in which LNG is loaded comes into port or is in standby status for entering port, none or small amount of boil-off gas is consumed, so that excessive boil-off gas is discharged.

The amount of boil-off gas discharged from the LNG transport vessel with a loading capacity of about 150,000 m³ is about 1.500 to about 2,000 tons per year. If being measured in terms of money, the above amount of boil-off gas is valued at six hundred million Korean Won. Furthermore, since boil-off gas is burned and discharged as it is, the environmental pollution would be caused.

In the meantime, unlike such a storage tank, i.e., low pressure tank, techniques for preventing boil-off gas from being generated in an LNG storage tank by maintaining boil-off gas at a high pressure of about 200 bars (gage pressure) without forming an insulating wall in the LNG storage tank are disclosed in Korean Laid-Open Patent Publication Nos. KR2001-0014021, KR2001-0014033, KR2001-0083920, KR2001-0082235, KR2004-0015294 and the like.

However, since the LNG storage tank has a remarkable thick thickness in order to accommodate boil-off gas in the LNG storage tank at a high pressure of about 200 bars, a cost for manufacturing the LNG storage tank would be increased and additional devices such as a high pressure compressor and the like for maintaining boil-off gas at a high pressure of about 200 bars are provided.

In addition to the above techniques, there is a technique of a pressure tank. In the above technique, since high volatile liquid is stored in a pressure tank under the conditions of normal temperature and extra high pressure, any issues relating to a boil-off gas treatment does not occur. However, there would be a restriction by which a size of the tank cannot be increased and a cost for manufacturing the tank is increased.

As described above, in the LNG storage tank (low pressure tank) of the LNG transport vessel, when liquid in a state of extremely low temperature is transported at an ambient pressure, the above pressure is constantly maintained and the generation of boil-off gas is allowed. Accordingly, in the LNG storage tank, consumption of boil-off gas would be increased and additional re-liquefying device is provided. In addition, unlike the low pressure tank being capable of transporting liquid in a state of extremely low temperature at a low pressure of ambient pressure, according to the method of transporting liquid in a state of extremely low temperature using a high pressure tank such as a pressure tank capable of withstanding high pressure, although boil-off gas need not be treated, dimensions of the tank would be restricted and a cost for manufacturing the tank is increased.

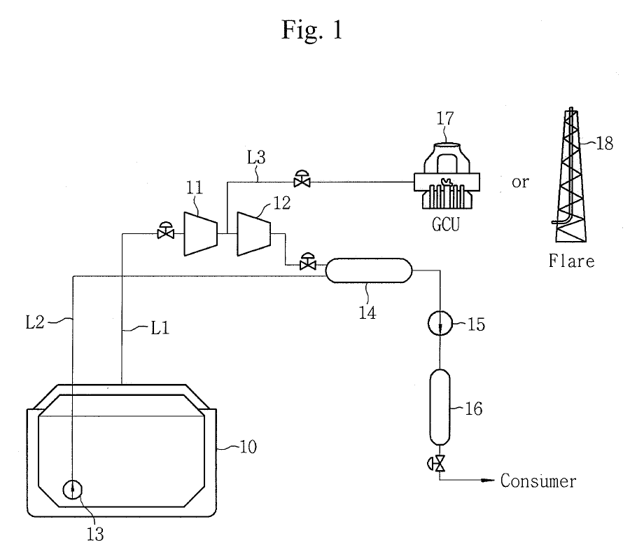

FIG. 1 is a view illustrating an example of method for treating boil-off gas. As shown in FIG. 1, boil-off gas generated in an LNG storage tank 10 is supplied to re-gasification facilities or consumed in a gas combustion unit 17 or a flare 18.

In order to supply boil-off gas discharged from the LNG storage tank 10 to the re-gasification facilities, boil-off gas supplied through a boil-off gas supply line L1 is first compressed by first and second compressors 11 and 12 and then mixed with LNG in a re-condenser 14, thereby being re-condensed (re-liquefied).

In this method, in order to be re-condensed through the re-condenser 14, the boil-off gas is compressed at a high pressure of about 10 bars, so that there are in that much power is consumed for compressing the boil-off gas and excessive costs are required for installing and operating the re-condenser 14.

In addition, the boil-off gas, which is mixed with LNG transported from the LNG storage tank 10 through an LNG supply line L2 by an LNG pump 13 and then re-condensed, is supplied together with LNG to an evaporator 16 by a high pressure pump 15, and then evaporated in the evaporator 16. Finally, the evaporated boil-off gas is supplied to markets.

At this time, if a small re-gasification load is applied to the re-gasification facilities such as the evaporator 16, surplus boil-off gas is supplied to the gas combustion unit 17 or the flare 18 through a boil-off gas discharge line L3 branching off from a line between the first and second compressors 11 and 12, so that all the surplus boil-off gas is consumed.

As described above, surplus boil-off gas which cannot be treated in re-gasification facilities is burned or discharged to the outside and thus the energy would be severely wasted and environmental pollution may be caused by the burning or discharge of boil-off gas.

A floating marine structure mentioned herein is a concept including a structure and a vessel, which floats on the sea and has a storage tank for storing liquid cargo such as LNG loaded at an extremely low temperature. For example, the floating marine structure includes a vessel such as an LNG RV, as well as a marine structure such as an LNG FPSO, or an LNG FSRU.

Generally, a pressure in an LNG storage tank of a LNG transport vessel is maintained within a certain range, so that most of heat transmitted from the outside is utilized for generating boil-off gas and all the boil-off gas generated as described above is treated in the LNG transport vessel. In certain embodiments of the present invention, however, an increase of pressure in an LNG storage tank provided in the floating marine structure is allowed, so that almost of transmitted heat caloric is adsorbed by an increased part of sensible heat of LNG and natural gas (hereinafter, referred to as “NG”) in the tank due to an increase of a saturation temperature according to an increase of a pressure. Consequently, the generation of boil-off gas is significantly reduced. For example, if an internal pressure of the LNG storage tank becomes about 0.7 bar, the saturation temperature rises by about 6° C. from an initial temperature at an initial pressure of about 0.06 bar.

In case of an LNG storage tank in which an insulating wall is formed, when LNG is normally loaded, an initial internal pressure is approximately 0.06 bar (gage pressure), boil-off gas is generated and an internal pressure is gradually increased in proportion to a period for which LNG is stored in the floating marine structure. For example, an internal pressure of the LNG storage tank is about 0.06 bar after LNG is loaded in an LNG producing area, and if the floating marine structure is sailed for about 15 to about 20 days and the reaches a destination, the internal pressure of the LNG storage tank can be increased up to about 0.7 bar.

The foregoing will be described in a relation to a temperature. In general, various impurities are contained in LNG, so that a boiling point of LNG is lower than that of pure methane liquid. The boiling point of pure methane liquid is about −161° C. at a pressure of about 0.06 bar, but the real boiling point of LNG, which is transported to the LNG storage tank and contains purities, such as nitrogen, ethane and the like, to some extent, is around −163° C.

As described on the basis of pure methane, a temperature of LNG in the storage tank is around −161° C. at a pressure of 0.06 bar after LNG is loaded. Considering a transporting distance and the amount of boil-off gas to be consumed, a temperature of LNG is increased up to around −159° C. if a gas pressure in the tank is controlled to about 0.25 bar, a temperature of LNG is increased up to around −155° C. if a gas pressure in the tank is controlled to about 0.7 bar, and a temperature of LNG is increased up to around −146° C. if a gas pressure in the tank is controlled to about 2.0 bar.

The LNG storage tank according to one embodiment of the present invention is provided with an insulating wall and designed in view of an increase of the pressure caused by the generation of boil-off gas. That is, the LNG storage tank according to one embodiment of the present invention is designed to have the strength for enabling the LNG storage tank to withstand an increase of the pressure caused by the generation of boil-off gas. Accordingly, the boil-off gas generated in the LNG storage tank during the LNG storage period in the floating marine structure is accumulated in the LNG storage tank as it is.

For example, the LNG storage tank according to one embodiment of the present invention is provided with an insulating wall and designed to enable the LNG storage tank to withstand a pressure of about 0.25 to about 2.0 bars (gage pressure), more preferably a pressure of about 0.6 to about 1.5 bars. In consideration of the LNG storage period and the current international gas code (IGC), it is preferable that the LNG storage tank be designed to enable the LNG storage tank to withstand a pressure of about 0.25 to about 0.7 bar, particularly a pressured of around 0.7 bar. However, there are in that the LNG storage period becomes short if a pressure is remarkably low, and it is not easy to manufacture the storage tank if a pressure is excessively high.

In addition, the LNG storage tank according to one embodiment of the present invention can be sufficiently implemented by making a thickness thereof large when the LNG storage tank is initially designed or by adding only a reinforcement member to an LNG storage tank of a LNG transport vessel to reinforce suitably the LNG storage tank without significant modification in structure, so that the LNG storage tank according to one embodiment of the present invention is effective in manufacturing cost.

Almost all LNG storage tanks are designed so that the LNG storage tank can withstand a pressure of about 0.25 bar or less, boil-off gas is utilized as propelling fuel or re-liquefied until an internal pressure reaches about 0.2 bar or less, for example, about 0.1 bar and some or all of boil-off gas is burned in a gas combustion unit when an internal pressure is reached about 0.2 bar or more. In addition, the LNG storage tank is provided with a safety valve, so that when the above control is failed, boil-off gas is discharged to the outside of the LNG storage tank via the safety valve (with an opening/closing pressure of about 0.25 bar, in general) and then discharged to the atmosphere through a flare.

In certain embodiments of the present invention, however, it is possible to set an opening pressure of a safety valve provided in an upper portion of the LNG storage tank to approximately 0.7 bar. Additionally, the LNG storage tank according to one embodiment of the present invention is configured so that a pressure in the LNG storage tank is decreased by reducing a local increase of temperature and pressure. Boil-off gas with relatively high temperature located at an upper portion in the LNG storage tank is sprayed into LNG with relatively low temperature, so that a temperature distribution in the LNG storage tank can be uniformly maintained.

Since the amount of boil-off gas generated in the LNG storage tank is connected directly with an increase of pressure in the tank, in order to increase slowly the pressure in the tank, it is valuable to reduce the amount of generated boil-off gas.

In addition, if LNG in a supercooled state is loaded in the LNG storage tank at a terminal at which the LNG is produced, it is possible to more reduce the amount (an increase of pressure) of boil-off gas generated during the transportation of LNG. Immediately after the LNG in a supercooled state is loaded in the LNG storage tank at the producing terminal, an internal pressure of the LNG storage tank can be changed to a negative pressure (below zero (0) bar). In order to prevent the above phenomenon, it is possible to fill the LNG storage tank with nitrogen.

Hereinafter, a floating marine structure having an in-tank re-condensing unit and a method of treating boil-off gas in the floating marine structure according to an embodiment of the present invention will be described in detail with reference to the accompanying drawings.

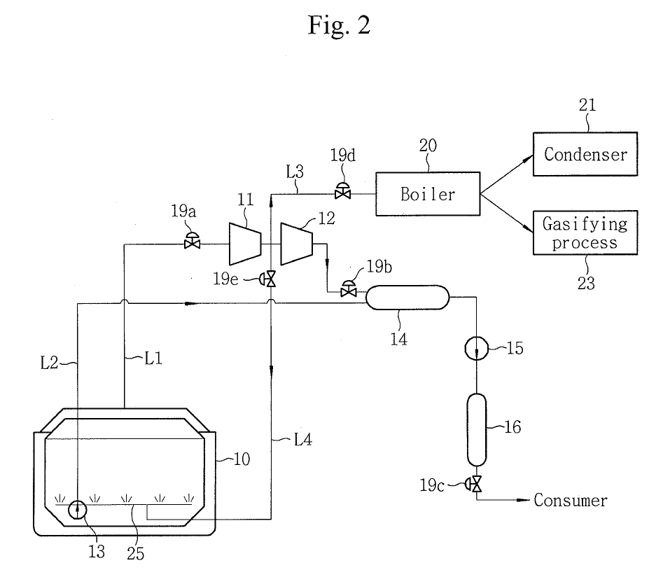

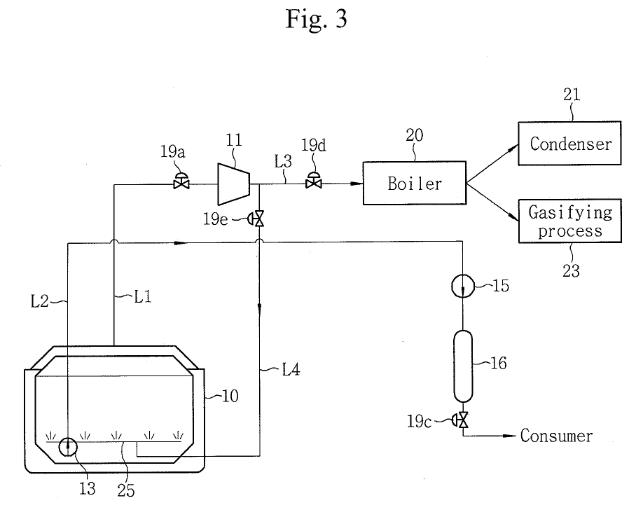

FIG. 2 is a view schematically showing the configuration of a floating marine structure having an in-tank re-condensing unit according to an embodiment of the present invention, and FIG. 3 is a view schematically showing the configuration of a floating marine structure having an in-tank re-condensing unit according to an embodiment of the present invention.

In the floating marine structure according to an embodiment of the present invention, as shown in FIG. 2, while re-gasification operation is not preformed, boil-off gas generated in an LNG storage tank 10 for storing LNG is compressed at low pressure and then returned to the LNG tank 10 to thereby allow the pressure in the storage tank to be increased. In addition, during the re-gasification operation, the generated boil-off gas is supplied to re-gasification facilities or utilized as a fuel of a boiler 20 for supplying heat source in a re-gasification process.

As described above, according to one embodiment of the present invention, the boil-off gas generated in the LNG storage tank 10 is not treated to allow an increase of internal pressure of the LNG storage tank. Accordingly, almost of transmitted heat is accumulated as a risen heat energy of LNG and NG in the tank by an increase of the internal temperature of the tank, and then, the boil-off gas accumulated in the LNG storage tank 10 is treated when LNG is unloaded, i.e., when LNG is re-gasified.

When the facilities for re-gasifying LNG operate, in order to supply the re-gasification facilities with boil-off gas discharged from the LNG storage tank 10, like the art, boil-off gas supplied through a boil-off gas supply line L1 is first compressed by first and second compressors 11 and 12 and then re-condensed (re-liquefied) in a re-condenser 14. At this time, the number of the compressors required for compressing boil-off gas can be varied as occasion demands, the amount of boil-off gas discharged from the LNG storage tank 10 and supplied to the first and second compressors 11 and 12 can be adjusted by a control valve 19a installed at an upstream side of the compressor.

According to one embodiment of the present invention, in a case where a small re-gasification load is applied to the re-gasification facilities or the re-gasification facilities does not operate, boil-off gas is compressed at low pressure and is then returned to the LNG storage tank 10 through a boil-off gas return line L4, as described below, thereby making it possible to reduce the amount of boil-off gas re-condensed in the re-condenser 14 or not to re-condense the boil-off gas. Accordingly, there is no need for compressing boil-off gas at high pressure, so that power required for compressing boil-off gas at high pressure can be reduced.

In the meantime, in order to supply LNG stored in the LNG storage tank 10 to the re-gasification facilities, the LNG is first supplied to the re-condenser 14 via an LNG supply line L2 by the LNG pump 13 installed in the LNG storage tank 10.

The boil-off gas, which is mixed with LNG transported from the LNG storage tank 10 through the LNG supply line L2 by the LNG pump 13 and then re-condensed, is supplied together with LNG to an evaporator 16 by a high pressure pump 15, and the boil-off gas is gasified and then supplied to markets. The amount of boil-off gas which is compressed and then supplied to the re-condenser 14 can be adjusted by a control valve 19b installed at an upstream side of the re-condenser 14, and the amount of natural gas gasified in the evaporator 16 and supplied to the markets can be adjusted by a control valve 19c installed at a downstream side of the evaporator 16.

At this time, in a case where a small re-gasification load is applied to the re-gasification facilities such the evaporator 16, surplus boil-off gas may be supplied to the boiler 20 through a boil-off gas-discharging line L3 branching off from a line between the first compressor 11 and the second compressor 12. The amount of boil-off gas supplied to the boiler 20 can be adjusted by a control valve 19d installed at an upstream side of the boiler 20.

The boiler 20 is generally included in the re-gasification facilities and serves to supply heat when LNG is gasified. In one embodiment of the present invention, the surplus boil-off gas generated in a re-gasification process is utilized as a fuel of this boiler 20, thereby preventing energy waste and environmental pollution.

In the boiler 20, steam is generated by the surplus boil-off gas, and the steam generated in the boiler is supplied to the condenser 21 or a gasification process 23 if necessary. In other word, if a large quantity of steam is required in the gasification process 23, all the steam generated in the boiler 20 is supplied to the gasification process 23 and utilized therein. Also, even if no steam or a small quantity of steam is required in the gasification process 23, the steam is continuously generated without a shutdown of the boiler to supply the condenser 21 with surplus steam, the amount of which is larger than that required in the gasification process 23. The surplus steam is condensed into water in the condenser 21 and the water is recycled or wasted.

In the gasification process 23 according to one embodiment of the present invention, besides the steam supplied from the boiler 20, it will be apparent that seawater or air may be used as a heat source solely or in combination when LNG is gasified.

On the other hand, while the re-gasification does not operate, the boil-off gas generated in the tank 10 for storing LNG is compressed in the first compressor 11 at a low pressure of approximately 2 bars (gage pressure) and then returned to the LNG storage tank 10 through the in-tank re-condensing mean 25. As described above, since the LNG storage tank 10 is manufactured so that the LNG storage tank allows an inner pressure to be increased up to approximately 0.7 bar (gage pressure), a margin of the pressure in the tank becomes large as compared with the storage tank allowing an inner pressure to be increased up to 0.25 bar (gage pressure).

The in-tank re-condensing unit 25 is installed at a downstream side of the first compressor 11, that is, a terminal end of the boil-off gas return line L4 branching off from the boil-off gas supply line L1 between the first compressor 11 and the second compressor 12. The in-tank re-condensing unit 25 may include a plurality of nozzles capable of spraying boil-off gas compressed at low pressure toward a lower portion of the LNG storage tank 10.

The amount of the boil-off gas returned to the LNG storage tank 10 by the in-tank re-condensing unit 25 can be adjusted by a control valve 19e installed on the boil-off gas return line L4.

According to such an embodiment of the present invention as described above, even if a gas combustion unit or a flare is not provided, while the re-gasification does not operates, boil-off gas is compressed at a relatively low pressure by the low pressure compressor (for example, the first compressor 11) without using a high pressure compressor, and can be then returned to the LNG storage tank 10 through the in-tank re-condensing unit 25. In addition, during the re-gasification operation, surplus boil-off gas can be treated in the boiler 20 included in the re-gasification facilities.

Accordingly, it is possible to reduce an initial investment cost required for installing a gas combustion unit or a flare and a cost required for operating the above apparatus. In addition, an operating cost for operating the high pressure compressor can be saved.

Also, according to an embodiment of the present invention, it is possible to prevent boil-off gas from being burned in a gas combustion unit or a flare or discharged to the atmosphere, so that it is possible to securely prevent energy waste and environmental pollution caused by the burning or discharging of boil-off gas.

Like the first embodiment as described above, in the floating marine structure according to an embodiment of the present invention as shown in FIG. 3, while the re-gasification does not operate, the boil-off gas generated in the tank 10 for storing LNG is compressed at low pressure and the compressed boil-off gas is then returned to the LNG storage tank 10 to thereby allow the pressure in the LNG storage tank to be increased. In addition, during the re-gasification operation, the boil-off gas generated in the LNG storage tank is supplied to the re-gasification facilities or used as fuel of the boiler 20 for supplying heat for a re-gasification.

However, the floating marine structure according to the second embodiment is provided with re-gasification facilities operated only in a closed mode. In this configuration, since the amount of boil-off gas required in the boiler 20 is larger than that generated spontaneously in the LNG storage tank 10, there is no need for re-liquefying boil-off gas generated in the LNG storage tank 10, whereby the re-condenser 14 utilized in the first embodiment is unnecessary.

According to the second embodiment, since the boil-off gas discharged from the LNG storage tank 10 is not supplied to the re-gasification facilities during the re-gasification operation, all the boil-off gas supplied through the boil-off gas supply line L1 is compressed by the first compressor 11 and then supplied to the boiler 20. At this time, the number of the compressors required for compressing boil-off gas can be varied as occasion demands, the amount of boil-off gas discharged from the LNG storage tank 10 and supplied to the compressor 11 can be adjusted by a control valve 19a installed at an upstream side of the compressor.

According to one embodiment of the present invention, in a case where a small re-gasification load is applied to the re-gasification facilities or the re-gasification facilities does not operate, boil-off gas can be compressed at low pressure and then returned to the LNG storage tank 10 through the boil-off gas return line L4.

In the meantime, in order to supply LNG stored in the LNG storage tank 10 to the re-gasification facilities, the LNG is first supplied to the high pressure pump 15 via an LNG supply line L2 by the LNG pump 13 installed in the LNG storage tank 10.

The boil-off gas supplied to the high pressure pump 15 is subsequently transported to the evaporator 16, and the natural gas gasified in this evaporator 16 is supplied to the markets. The amount of natural gas gasified in the evaporator 16 and then supplied to the markets can be adjusted by the control valve 19c installed at a downstream side of the evaporator 16.

The boiler 20 is generally included in the re-gasification facilities and serves to supply heat when LNG is gasified. In the second embodiment, the boil-off gas is utilized as a fuel of this boiler 20, thereby preventing energy waste and environmental pollution.

In the boiler 20, steam is generated using the boil-off gas as fuel, and the steam generated in the boiler is supplied to the condenser 21 or a gasification process 23 if necessary. In other word, if a large quantity of steam is required in the gasification process 23, all the steam generated in the boiler 20 is supplied to the gasification process 23 and utilized therein. Also, even if no steam or a small quantity of steam is required in the gasification process 23, the steam is continuously generated without a shutdown of the boiler to supply the condenser 21 with surplus steam, the amount of which is larger than that required in the gasification process 23. The surplus steam is condensed into water in the condenser 21 and the water is recycled or wasted.

In the gasification process 23 according to one embodiment of the present invention, besides the steam supplied from the boiler 20, it will be apparent that seawater or air may be used as a heat source solely or in combination when LNG is gasified.

On the other hand, while the re-gasification does not operate, the boil-off gas generated in the tank 10 for storing LNG is compressed in the first compressor 11 at a low pressure of approximately 2 bars (gage pressure) and then returned to the LNG storage tank 10 through the in-tank re-condensing mean 25. As described above, since the LNG storage tank 10 is manufactured so that the LNG storage tank allows an inner pressure to be increased up to approximately 0.7 bar (gage pressure), a margin of the pressure in the tank becomes large as compared with the storage tank allowing an inner pressure to be increased up to about 0.25 bar (gage pressure).

The in-tank re-condensing unit 25 is installed at a downstream side of the first compressor 11, that is, a terminal end of the boil-off gas return line L4 branching off from the boil-off gas supply line L1 between the first compressor 11 and the second compressor 12. The in-tank re-condensing unit 25 may include a plurality of nozzles capable of spraying boil-off gas compressed at low pressure toward a lower portion of the LNG storage tank 10.

The amount of the boil-off gas returned to the LNG storage tank 10 by the in-tank re-condensing unit 25 can be adjusted by a control valve 19e installed on the boil-off gas return line L4.

According to such an embodiment of the present invention as described above, even if a gas combustion unit or a flare is not provided, while the re-gasification does not operates, boil-off gas is compressed at a relatively low pressure by the low pressure compressor (for example, the first compressor 11) without using a high pressure compressor, and can be then returned to the LNG storage tank 10 through the in-tank re-condensing unit 25.

In addition, during the re-gasification operation, all the boil-off gas can be treated in the boiler 20 included in the re-gasification facilities. As described above, since the boil-off gas is not re-liquefied in the re-condenser 14, the re-condenser 14 can also be omitted. Thus, it is possible to reduce an initial investment cost required for installing the gas combustion unit 17 or the flare 18 and the re-condenser 14 and a cost required for operating the above equipments. In addition, an operating cost for operating the high pressure compressor can be saved.

Also, according to an embodiment of the present invention, it is possible to prevent boil-off gas from being burned in a gas combustion unit or a flare or discharged to the atmosphere, so that it is possible to securely prevent energy waste and environmental pollution caused by the burning or discharging of boil-off gas.

According to one embodiment of the present invention as described above, it is possible to provide a floating marine structure having an in-tank re-condensing unit, wherein boil-off gas generated in a liquefied gas storage tank is compressed at low pressure and boil-off gas is returned to the storage tank again, thereby saving power consumed due to a re-condenser in which boil-off gas is compressed at high pressure, and a method of treating boil-off gas in the floating marine structure

In addition, according to one embodiment of the present invention, while the re-gasification does not operate, boil-off gas generated in a storage tank for storing liquefied gas is compressed at low pressure and then returned to the storage tank to allow the pressure in the storage tank to be increased. During the re-gasification operation, boil-off gas generated in the storage tank is used as fuel of the boiler for supplying heat for the re-gasification, so that of energy waste and environmental pollution can be prevented.

Although embodiments of the present invention have been described with reference to the drawings, the present subject matter is not limited to the embodiments and drawings illustrated above. It will be apparent that those skilled in the art can make various modifications and changes thereto within the scope of the invention defined by the claims.

What is claimed is:

1. A floating marine structure, comprising:
a liquefied natural gas (LNG) storage tank configured to accommodate LNG;
an LNG re-gasification apparatus configured to re-gasify LNG accommodated in the LNG storage tank; and
an in-tank re-condensing unit configured to re-condense boil-off gas generated in the LNG storage tank by spraying the boil-off gas toward a lower portion of the LNG storage tank,
wherein the boil-off gas is returned to the LNG storage tank through the in-tank re-condensing unit, whereby the boil-off gas is re-condensed in the LNG storage tank.

2. The floating marine structure as claimed in claim 1, wherein the in-tank re-condensing unit comprises a nozzle installed to the lower portion of the LNG storage tank.

3. The floating marine structure as claimed in claim 1, further comprising a boiler to supply heat for re-gasification of LNG, wherein when the LNG re-gasification apparatus are not operated, the boil-off gas is returned to the LNG storage tank through the in-tank re-condensing unit, and when the LNG re-gasification facilities are operated, the boil-off gas is burned in the boiler to generate heat which is supplied to the LNG re-gasification apparatus.

4. The floating marine structure as claimed in claim 1, further comprising a re-condenser for re-liquefying the boil-off gas generated in the LNG storage tank.

5. The floating marine structure as claimed in claim 3, further comprising a boil-off gas supply line configured to flow at least a portion of the boil-off gas generated in the LNG storage tank to the boiler through a compressor.

6. The floating marine structure as claimed in claim 4, further comprising a boil-off gas supply line configured to flow at least a portion of the boil-off gas generated in the LNG storage tank to the re-condenser via a compressor.

7. The floating marine structure as claimed in claim 6, further comprising a boiler to supply heat for re-gasification of LNG; and a boil-off gas discharge line branching off from the boil-off gas supply line and configured to supply another portion of the boil-off gas to the boiler.

8. The floating marine structure as claimed in claim 1, further comprising a boil-off gas return line configured to supply at least a portion of the boil-off gas generated in the LNG storage gas to the in-tank re-condensing unit through the compressor.

9. An apparatus for containing LNG, the apparatus comprising:
an LNG tank containing liquid phase LNG and boil-off gas of LNG;
an circulating device comprising an intake port and a discharge port, the circulating device further comprising an flowing pathway from the intake port to the discharge port that does not include a forced LNG liquefying device;
the intake port being located in an upper portion of the LNG tank; and
the discharge port being located in a lower portion of the LNG tank substantially lower than the intake port,
wherein the circulating device is configured to suction, through the intake port, boil-off gas from the upper portion of the LNG tank and to discharge boil-off gas, through the discharge port, to the lower portion of the LNG tank.

10. The apparatus of claim 1, wherein the circulating device further comprises a compressor configured to compress at least part of the boil-off gas flowing in the flowing pathway between the intake port and the discharge port.

11. The apparatus of claim 9, wherein the intake port is located at or near a top surface of the LNG tank.

12. The apparatus of claim 9, wherein the discharge port is substantially distanced from an interior surface of the LNG tank.

13. The apparatus of claim 9, wherein the circulating device further comprises a branch pathway branching from the flowing pathway and not returning to the flowing pathway.

14. The apparatus of claim 9, wherein the flowing pathway comprises a portion located outside the LNG tank.

15. A ship comprising the apparatus of claim 9, wherein the LNG tank is integrated with a body of the ship.

16. The ship of claim 15, wherein the LNG tank comprises an outlet configured to discharge liquid phase LNG therethrough when unloading the LNG from the LNG tank, wherein the ship further comprises an evaporator configured to evaporate liquid phase LNG discharged through the outlet.

17. The ship of claim 16, further comprising a burner, wherein the burner is connected to the circulating device so as to receive at least part of boil-off gas flowing between the intake port and the discharge port.

18. The ship of claim 16, further comprising a mixer connected to the evaporator and further connected to the LNG circulating device, whereby the mixer is configured to mix the LNG discharged from the outlet and a portion of LNG flowing between the intake port and the discharge port.

19. A method of processing boil-off gas of LNG contained in a LNG tank, the method comprising:
providing the apparatus of claim 9;
suctioning, through the intake port, boil-off gas from the upper portion of the LNG tank;
flowing, through the flowing pathway, boil-off gas from the intake port toward the discharge port; and
discharging, through the discharge port, boil-off gas from the flowing pathway into the lower portion of the LNG tank.

20. The method of claim 19, further comprising:
compressing at least part of boil-off gas flowing in the flowing pathway toward the discharge port; and
flowing compressed boil-off gas toward the discharge port.

21. The method of claim 19, wherein substantially no liquid phase LNG is suctioned through the intake port.

22. The method of claim 19, wherein the discharge port is submerged in liquid phase LNG.
